(19) United States
(12) Patent Application Publication
(10) Pub. No.: US 2005/0204018 A1
(43) Pub. Date: Sep. 15, 2005

(54) NETWORKED SYSTEM AND METHOD FOR MANAGING COMPUTER MEMORY IN THE NETWORKED SYSTEM

(75) Inventor: Kevin M. Jensen, Carson City, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/708,532

(22) Filed: Mar. 10, 2004

(51) Int. Cl. G06F 15/177; G06F 15/16

(52) U.S. Cl. 709/219; 709/232

(57) ABSTRACT

A networked system and a method for managing computer memory in the networked system are provided. The method includes determining when a first web page is being closed or a second web page is being opened on a first computer. The first web page has an embedded software object therein. The method further includes in response to the first web page being closed or the second web page being opened, executing a software function in the embedded software object that both transmits a first data message to a second computer instructing the second computer to stop sending the predetermined information to the embedded software object and releases memory in the first computer associated with the embedded software object.

### BACKGROUND OF INVENTION

In a networked computer system, a client computer may have a web page that contains embedded software objects that each request information from a web server. Further, the web computer server can set up a plurality of communication sessions with one or more other computer servers to route the requested information through the web computer server to the embedded software objects of the client computer. However, when a web page is closed by a user or the user opens another web page on the client computer, the plurality of communication sessions set up between the web computer server and the other computer servers are not needed since the requested information is no longer needed. Generally, the various computer servers wait to “clean up” or close the communication sessions at some specified “clean up” time.

However, by waiting to “clean up” or close the communication sessions, the random-access memory (RAM) allocated for these communication sessions in the web computer server and other computer servers cannot be used by other user communication sessions needing additional RAM or for additional user communication sessions. Thus, the quality of service for all users of the web computer server and the users of the other computer servers communicating with the web computer server can be reduced.

Thus, there is thus a need for a method and system for releasing the RAM associated with communication sessions between the web computer server and the other computers servers in response to a web page on a client computer being closed or another web page being opened.

### SUMMARY OF INVENTION

A method for managing computer memory in a networked system in accordance with an exemplary embodiment is provided. The method includes determining when a first web page is being closed or a second web page is being opened on a first computer. The first web page has an embedded software object therein. The method further includes in response to the first web page being closed or the second web page being opened, executing a software function in the embedded software object that both transmits a first data message to a second computer instructing the second computer to stop sending predetermined information to the embedded software object, and releases memory in the first computer associated with the embedded software object.

A method for managing computer memory in a networked system in accordance with another exemplary embodiment is provided. The method includes determining when a first web page is being closed or a second web page is being opened on a first computer. The first web page has a plurality of embedded software objects therein. The method further includes in response to the first web page being closed or the second web page being opened, executing a software function in each of the plurality of embedded software objects that both transmits a first data message to a second computer instructing the second computer to stop sending predetermined information to the embedded software object, and releases memory in the first computer associated with the embedded software object.

A networked system in accordance with another exemplary embodiment is provided. The networked system includes a first computer operably communicating with a second computer. The first computer has a first web page including an embedded software object therein. The first computer in response to the first web page being closed or a second web page being opened, executes a software function in the embedded software object that both transmits a first data message to the second computer instructing the second computer to stop sending predetermined information to the embedded software object, and releases memory in the first computer associated with the embedded software object.

A networked system in accordance with another exemplary embodiment is provided. The networked system includes a first computer operably communicating with a second computer. The first computer has a first web page including a plurality of embedded software objects therein. The first computer in response to the first web page being closed or a second web page being opened, executes a software function in each of the embedded software objects that both transmits a first data message to a second computer instructing the second computer to stop sending predetermined information to the embedded software object, and releases memory in the first computer associated with the embedded software object.

Other systems and/or methods according to the embodiments will become or are apparent to one with skill in the art upon review of the following drawings and detailed description. It is intended that all such additional systems and methods be within the scope of the present invention, and be protected by the accompanying claims.

### BRIEF DESCRIPTION OF DRAWINGS

FIG. 1 illustrates a networked system in accordance with an exemplary embodiment;

FIG. 2 is a schematic of a computer monitor having an exemplary web page;

FIGS. 3-7 are flowcharts of a method of managing computer memory in the networked system of FIG. 1 in accordance with another exemplary embodiment.

### DETAILED DESCRIPTION

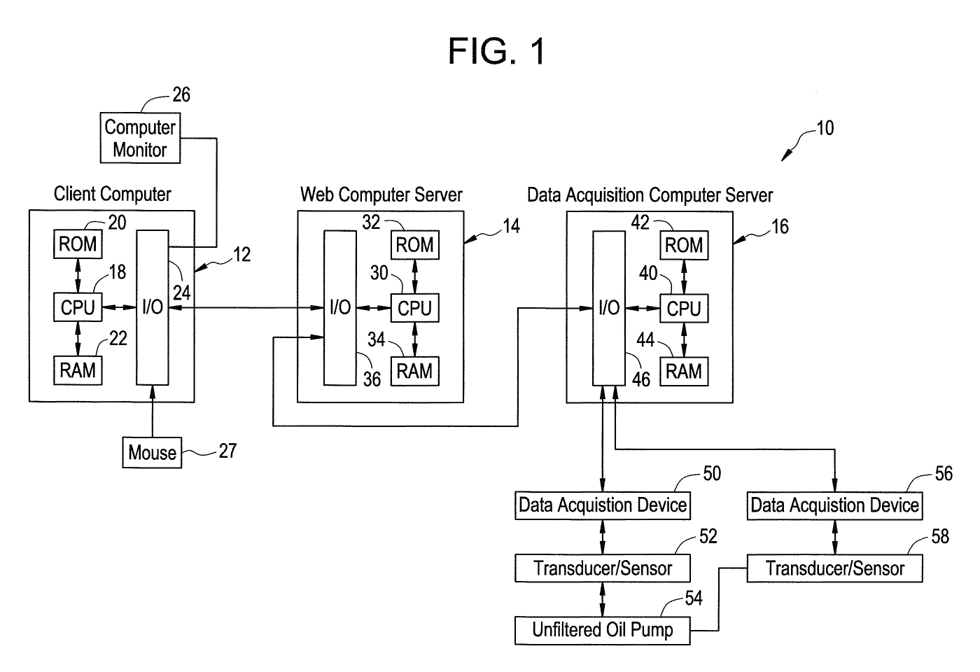

Referring to FIG. 1, a networked system 10 for obtaining and displaying information relating to manufacturing equipment is illustrated. The networked system 10 includes a client computer 12, a web computer server 14, a data acquisition computer server 16, data acquisition devices 50, 56, sensors 52, 58, and an oil pump 54. The acquisition computer server 16 receives signals indicating either a measured value or a status value associated with manufacturing equipment, such as the oil pump 54 for example. The data acquisition computer server then transmits data messages to the web computer server containing either the measured value or the status value. Upon request by the client computer 12, the web computer server 14 can send a data message to the client computer 12 containing the measured value or the status value. Thereafter, the client computer 12 can display the measured value or the status value on a computer monitor 26. The operation of networked system 10, and in particular a method for managing memory within networked system 10 will be explained in greater detail below.

It should be noted that although only one client computer 12 is shown in system 10, a plurality of additional client computers could communicate with web computer server 14 in system 10. Further, although only one data acquisition computer server is shown in system 10, a plurality of additional data acquisition computer servers could communicate with web computer server 14 in system 10. A computer is defined as any device capable of performing a calculation.

The client computer 12 is provided to request measured values or status values associated with manufacturing equipment and then upon receipt of the values to display them on the computer monitor 26. As shown, the client computer 12 includes a microprocessor 18, a read-only memory (ROM) 20, a random access memory (RAM) 22, and an input/output (I/O) interface 24. The microprocessor 18 operably communicates with the ROM 20, the RAM 22, and the I/O interface 24. The ROM 20 and RAM 24 may be implemented using any of a number of known memory devices such as PROMs, EPROMs, EEPROMS, flash memory or any other electric, magnetic, optical or combination memory device capable of storing data, some of which represent executable instructions used by microprocessor 18. The microprocessor 18 communicates via the I/O interface 24 with the web computer server 14, the computer monitor 26, and a mouse 27.

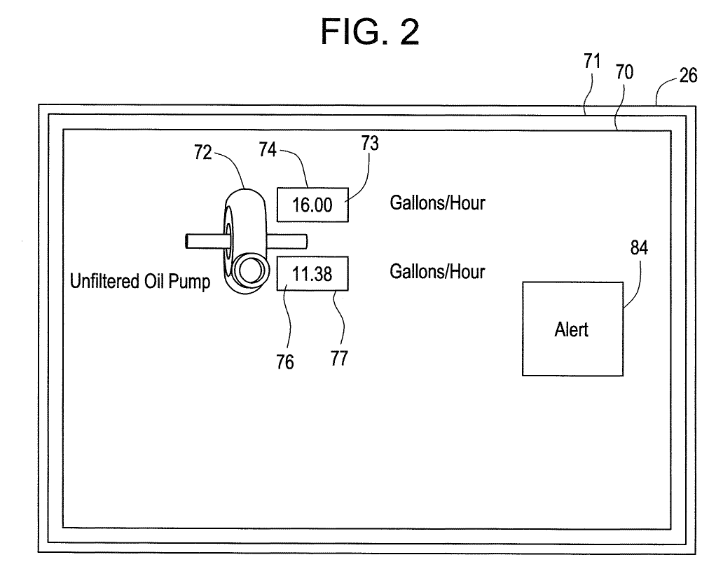

Referring to FIG. 2, the computer monitor 26 displays a web page 70 that contains information relating to either (i) measured operating parameters associated with a predetermined device, such as oil pump for example, or (ii) the operational status of the predetermined device. A web page is defined as an HTML document that can be used in a computer or an equivalent document that can be used in a computer. The web page 70 includes an image 72 that graphically represents an oil pump 54, respectively. The web page 70 further includes two embedded software objects comprising text boxes 74, 76. An embedded software object is defined as information in a document or web page that is a copy of information created in another software application. It should be noted that although web page 70 only includes two embedded software objects, the web page 70 could include a plurality of additional embedded software objects corresponding to additional measurement points or sensors in a manufacturing facility. Further, although the predetermined device is an oil pump, the predetermined device could comprise any device that can be utilized in a manufacturing facility. For example, the device could be an electrically actuated device, such as an electrical motor, a pneumatically actuated device, or a hydraulically actuated device.

Referring to FIGS. 1 and 2, each of the embedded software objects 74, 76 can request a measured value associated with the oil pump 54 that is displayed on web page 70. For example, embedded software objects 74, 76 can request and obtain an outlet flow rate and an inlet flow rate of the oil pump 54, respectively, that may correspond to a value of 16.00 gallons per hour and 11.38 gallons per hour, respectively. The two values 16.00 and 11.38 can be displayed on the web page 70.

Further, each of the embedded software objects 74, 76 can request a status value associated with the oil pump 54 that is displayed on web page 70. For example, embedded software object 74 can request and obtain a status value associated with the oil pump 54 at the location of outlet flow sensor 52. If a returned status value indicates normal operation, embedded software object 74 can set the box area 73 to a green color. Otherwise, the embedded software object 74 can set the box area 73 to a red color indicating an alert condition, and further set the alert box 84 to a red color, indicating an alert condition. Further, for example, embedded software object 76 can request and obtain a status value associated with the oil pump 54 at the location of inlet flow sensor 58. If the status value indicates operation of pump 54 within a predetermining operating range, the embedded software object 76 can set the box area 77 to a green color. Otherwise, the embedded software object 76 can set the box area 77 to a red color indicating an alert condition and further set the alert box 84 to a red color, indicating an alert condition.

To explain how embedded software objects request and obtain the measured values and the status values, a brief discussion of the structure of “query data messages” transmitted by embedded software objects 74, 76, will be explained.

A query data message transmitted from the client computer 12 to the web computer server 14 includes: (i) a Segment ID, (ii) a static data request, and (iii) a status data request. The Segment ID is a unique number that corresponds to a measurement point or sensor on the predetermined device. For example, a first Segment ID can be associated with flow sensor 52 and a second Segment ID can be associated with flow sensor 58.

A static data request is a request for a measurement value generated by a predetermined sensor. A static data request results in the measurement value being returned to the requesting embedded software object from the web computer server 14. The measurement value can correspond to a numerical value, such as a flow rate, a vibration amount, or any other measured operating parameter associated with a device or system.

A status data request is a request for a status value indicating an operating status of a device. The status data request results in a status value generated by the data acquisition computer server 16 or a data acquisition device that is returned to the requesting embedded software object from the web computer server 14. The data acquisition computer server 16 can determine whether a measured value associated with a Segment ID is within a predetermined operating range. If the measured value is within the predetermined operating range, the status value can be set to a binary “1” value, for example. Otherwise, the status value can be set to a binary “0” value, indicating an alert condition, for example.

Each of the embedded software objects 74, 76 can also generate “memory control messages” that will now be explained. In particular, when the web page 70 is closed or another web page (not shown) is opened, a JavaScript in web page 70 can call a “cleanup” function in each of embedded software objects 74, 76. The cleanup function transmits the “memory control data message” to the web computer server 14 that includes: (i) a Segment ID, and (ii) a Data Termination Code. The Data Termination Code corresponds to a numerical value that instructs the web computer server 14 to no longer send information relating to the specified Segment ID to the client computer 12. The cleanup function also releases all memory in RAM 22 of client computer 12 associated with the embedded software object executing the cleanup function.

Referring to FIG. 1, the web computer server 14 is provided to route requests for information (e.g., query data messages) identified by Segment IDs from client computer 12 to data acquisition computer 16. Further, the web computer server 14 is provided to route information identified by Segment IDs from the data acquisition computer server 16 to the client computer 12. To accomplish the routing of information, web computer server 14 is configured to set up a first communication session between the server 14 and the client computer 12. Further, the web computer server 14 is configured to set up a plurality of communication sessions between the server 14 and data acquisition computer server 16 for: (i) each received Segment ID having a static data request, and for (ii) each received Segment ID having a status data request. Thus, when the client computer 12 is requesting information related to a first plurality of Segment IDs each having static data requests, web computer server 14 sets up a first plurality of communication sessions with data acquisition computer server 16. Similarly, when the client computer 12 requests information related to a second plurality of segment IDs each having status data request, web server 14 sets up a second plurality of communication sessions with data acquisition computer server 16.

It should be noted that for each communication session between the web computer server 14 and the data acquisition computer server 16, server 14 allocates a predetermined amount of memory in RAM 34 for each communication session, and server 16 allocates a predetermined amount of memory in RAM 44 for each communication session.

As shown, the web computer server 14 includes a microprocessor 30, a ROM 32, a RAM 34, and an I/O interface 36. The microprocessor 30 operably communicates with the ROM 32, the RAM 34, and the I/O interface 36. The ROM 32 and RAM 34 may be implemented using any of a number of known memory devices such as PROMs, EPROMs, EEPROMS, flash memory or any other electric, magnetic, optical or combination memory device capable of storing data, some of which represent executable instructions used by microprocessor 30. The microprocessor 30 communicates via the I/O interface 36 with the client computer 12 and the data acquisition computer server 16 via the I/O interface 36.

When the web computer server 14 first receives a “query data message” including: (i) a Segment ID, (ii) a static data request, and (iii) a status data request from an embedded software object of the client computer 12, the CPU 30 sets up first and second communication sessions with the data acquisition computer server 16 to obtain the requested information. In particular, the web computer server 14 sends a first “query data message” including: (i) a Segment ID, and (ii) a static data request to the data acquisition computer server 16. Further, the web computer server 14 sends a second “query data message” including (i) a Segment ID, and (ii) a status data request to the server 16. Thereafter, the data acquisition computer server 16 periodically sends the requested static data and status data to the web computer server 14. Upon receipt of the static data and status data by the web computer server 14 from the data acquisition computer server 16, CPU 30 stores the information in the RAM 34.

Thereafter, when the web computer server 14 receives a request from client computer 12 for a static value, the CPU 30 retrieves the previously stored static value from the RAM 34, and transmits a data message to the client computer 12 including the Segment ID and associated static value. Similarly, when the web computer server 14 receives a request from client computer 12 for a status value, the CPU 30 retrieves the previously stored status value from RAM 34, and transmits a data message to the client computer 12 including the Segment ID and associated status value.

When the web computer server 14 receives a first “memory control data message” from the client computer 12 including: (i) a Segment ID, and (ii) a Data Termination Code, and the server 14 has no other client computers requesting information relating to the Segment ID, the CPU 30 sends a second “memory control data message” to the data acquisition computer server 16 requesting that all communication sessions between server 14 and server 16 for the respective Segment ID be terminated. Thereafter, the CPU 30 also releases the memory in RAM 34 associated with the communication sessions between server 14 and server 16 for the respective Segment ID.

The data acquisition computer server 16 is provided to receive requests for information identified by Segment IDs from the web computer server 14. Further, the data acquisition computer server 16 is provided to query data acquisition devices 50, 56 to obtain measurement values requested by a static data request from web computer server 14.

As shown, the data acquisition computer server 16 includes a microprocessor or CPU 40, a ROM 42, a RAM 44, and an I/O interface 46. The microprocessor 40 operably communicates with the ROM 42, the RAM 44, and the I/O interface 46. The ROM 42 and RAM 44 may be implemented using any of a number of known memory devices such as PROMs, EPROMs, EEPROMS, flash memory or any other electric, magnetic, optical or combination memory device capable of storing data, some of which represent executable instructions used by microprocessor 40. The microprocessor 40 communicates with the web computer server 14 and the data acquisition devices 50, 56 via I/O interface 46.

As shown, data acquisition device 50 is coupled to a flow sensor 52 and receives a first signal indicative of a flow rate through an outlet of oil pump 54. Similarly, data acquisition device 56 is coupled to a flow sensor 58 that generates a second signal indicative of a flow rate through an inlet of oil pump 54.

When the data acquisition computer server 16 first receives a “query data message” from the web computer server 14 having both a Segment ID indicative of flow sensor 52 and a static data request, data acquisition computer server 16 begins storing values in RAM 44 based on the first signal from first flow sensor 52. Thereafter, server 16 periodically transmits a data message to the web computer server 14 including the requested static data values associated with sensor 52.

Similarly, when data acquisition computer server 16 first receives a “query data message” from the web computer server 14 having both a Segment ID indicative of second flow sensor 58 and a static data request, data acquisition computer server 16 begins storing static data values in RAM 44 based on the second signal from flow sensor 58. Thereafter, server 16 periodically transmits a data message the to web computer server 14 including the requested static data values associated with sensor 58.

When the data acquisition computer server 16 first receives a “query data message” from web computer server 14 having both a Segment ID indicative of flow sensor 52 and a status data request, data acquisition computer server 16 begins storing status values in RAM 44. The status values can have a binary “1” value if the first signal from sensor 52 is within a predetermined signal range. Otherwise, the status values can have a binary “0” value. Thereafter, server 16 periodically transmits a data message to web computer server 14 including the requested status values associated with sensor 52.

Similarly, when data acquisition computer server 16 first receives a “query data message” from the web computer server 14 having a Segment ID indicative of flow sensor 58 and a status data request, data acquisition computer server 16 begins storing values in RAM 44 having values determined by whether the second signal from flow sensor 58 falls within a predetermined range. Thereafter, server 16 periodically transmits a data message to web computer server 14 including the requested status values associated with sensor 58.

When the data acquisition computer server 16 receives a “memory control data message” from the web computer server 14 indicating that the communication sessions between server 14 and server 16 for specified Segment IDs are to be terminated, the server 16 releases memory in RAM 44 associated with the communication sessions.

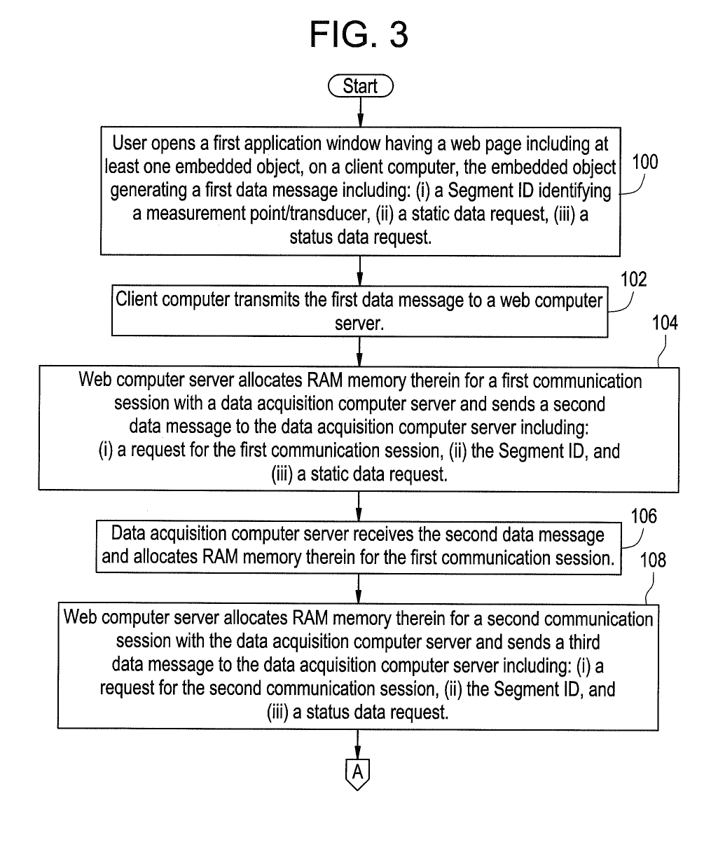

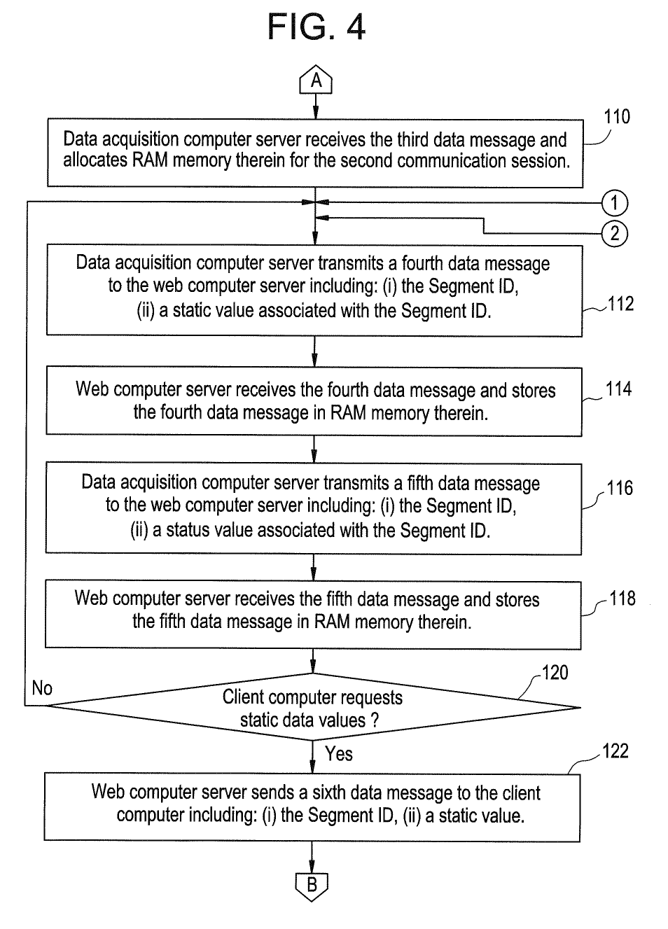

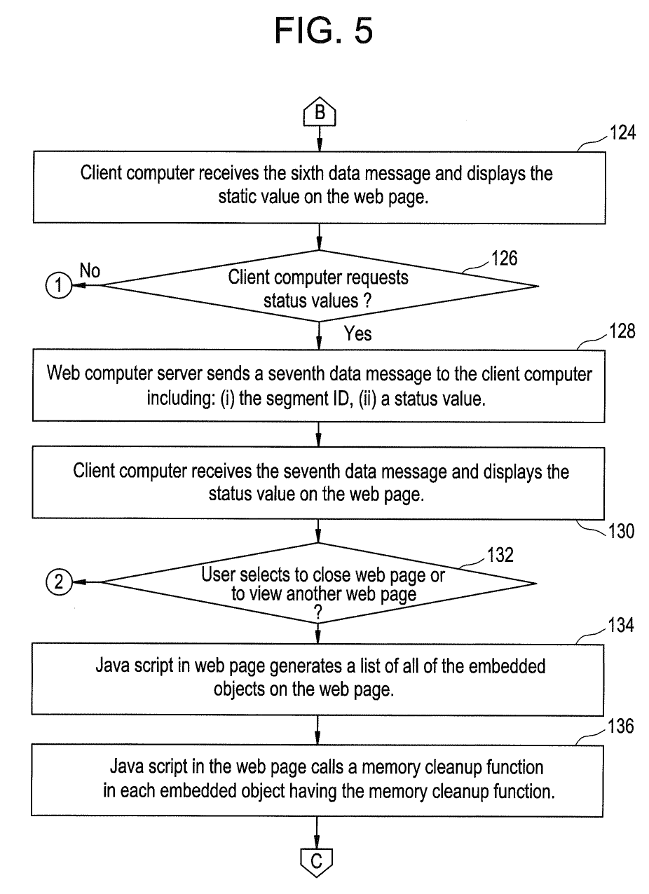

Referring to FIGS. 3-7, a method for managing computer memory in networked system 10 will now be explained in greater detail. The networked computers set up communication sessions there between to route requested data to embedded software objects on a web page. Thereafter, when the web page is closed or another web page is opened, the method releases memory in the networked computers dedicated to the previously set up communication sessions. For simplicity of understanding, the method will explain the management of memory in system 10 associated with one embedded software object (e.g., embedded software object 74) of web page 70. It should be noted, however, that the method could be utilized for a plurality of embedded software objects on a web page.

At step 100, the user opens a first software application window 71 having a web page 70 including at least one embedded software object 74. The embedded software object 74 generates a first data message including: (i) a Segment ID identifying a measurement point or sensor 52, (ii) a static data request, and (iii) a status data request.

At step 102, the client computer 12 transmits the first data message to the web computer server 14.

At step 104, the web computer server 14 allocates memory in RAM 34 for a first communication session with the data acquisition computer server 16 and sends a second data message to the server 16 including: (i) a request for the first communication session, (ii) the Segment ID associated with sensor 52, and (iii) a static data request. The first communication session will be used for transferring a static value (e.g. a measurement value) associated with sensor 52 from server 16 to web computer server 14.

At step 106, the data acquisition computer server 16 receives the second data message and allocates memory in RAM 44 for the first communication session with the web computer server 14.

At step 108, the web computer server 14 allocates memory in RAM 34 for a second communication session with the data acquisition computer server 16 and sends a third data message to the server 16 including: (i) a request for the second communication session, (ii) the Segment ID associated with sensor 52, and (iii) a status data request. The second communication session will be used for transferring a status value associated with sensor 52 from server 16 to web computer server 14.

At step 110, the data acquisition computer server 16 receives the third data message and allocates memory in RAM 44 for the second communication session with the web computer server 14.

At step 112, the data acquisition computer server 16 transmits a fourth data message to the web computer server 14 including: (i) the Segment ID associated with the sensor 52, and (ii) a static value associated with the Segment ID.

At step 114, the web computer server 14 receives the fourth data message and stores the fourth data message in RAM 34.

At step 116, the data acquisition computer server 16 transmits a fifth data message to the web computer server 14 including: (i) the Segment ID associated with the sensor 52, and (ii) a status value associated with the Segment ID.

At step 118, the web computer server 14 receives the fifth data message and stores the fifth data message in RAM 34.

At step 120, the web computer server 14 makes a determination as to whether the client computer 12 has requested the latest static values associated with the Segment ID. If the value of step 120 equals “no”, the method returns to step 112. Otherwise, the method advances to step 122.

At step 122, the web computer server 14 sends a sixth data message to the client computer including: (i) the Segment ID associated with sensor 52, and (ii) a static value associated with the Segment ID.

At step 124, the client computer 12 receives the sixth data message and displays the static value on the web page 70. For example, the client computer 12 can display the static value of 16.00 in the text box 74 corresponding to a flow rate of 16 gallons per hour through oil pump 54 measured by sensor 52.

At step 126, the web computer server 14 makes a determination as to whether the client computer 12 has requested the latest status values associated with the Segment ID. If the value of step 126 equals “no”, the method returns to step 112. Otherwise, the method advances to step 128.

At step 128, the web computer server 14 sends a seventh data message to the client computer 12 including: (i) the Segment ID associated with the sensor 52, and (ii) a status value associated with the Segment ID.

At step 130, the client computer 12 receives the seventh data message and displays the status value on the web page 70. For example, the client computer 12 can display the status value indicative of an alert condition by setting the color of the text box 74 equal to a red color. Alternately, for example the client computer can display the static value indicative of normal operation by setting the color of the text box 74 equal to a green color.

At step 132, client computer 12 makes a determination as to whether a user has selected to close web page 70 or to view another web page (not shown) using the mouse 27. If the value of step 132 equals “no”, the method returns to step 112. Otherwise, the method advances to step 134.

At step 134, a JavaScript in web page 70 generates a list of all of the embedded software objects on the web page 70. For example the JavaScript could generate a list that includes the embedded software object 74. Further, the list could include the embedded software objects 76, 84, although as discussed above, objects 76, 84 will not be described in this method for purposes of simplicity.

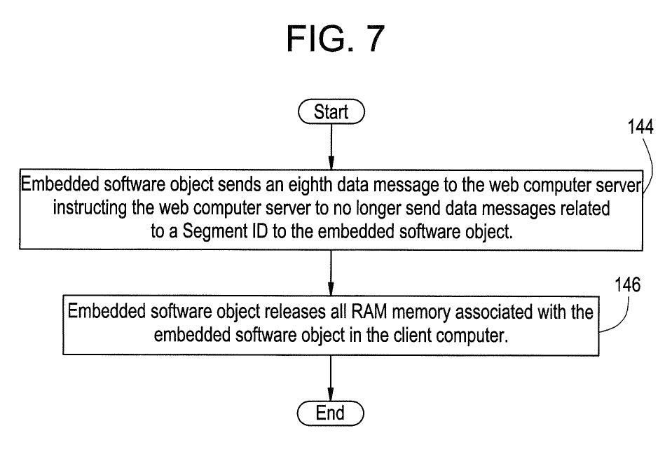

At step 136, the Java script in the web page 70 calls a “memory cleanup function” in each embedded software object having the memory cleanup function. For example, the Java script in the web page 70 calls a memory cleanup function in embedded software object 74. Referring to FIG. 7, the step 136 can be implemented by steps 144 and 146.

At step 144, the embedded software object 74 sends an eighth data message to the web computer server 14 instructing the web computer server 14 to no longer send data messages having the segment ID associated with sensor 52 to the embedded software object 74. In other words, since the web page 70 has either been closed or another web page is being opened, a user of client computer 12 will no longer be viewing text box 74, and thus there is no longer any need for web computer server 14 to continue to allocate RAM for transmitting information related to the Segment ID to text box 74.

At step 146, the embedded software object 74 releases all memory in RAM 22 associated with the embedded software object 74.

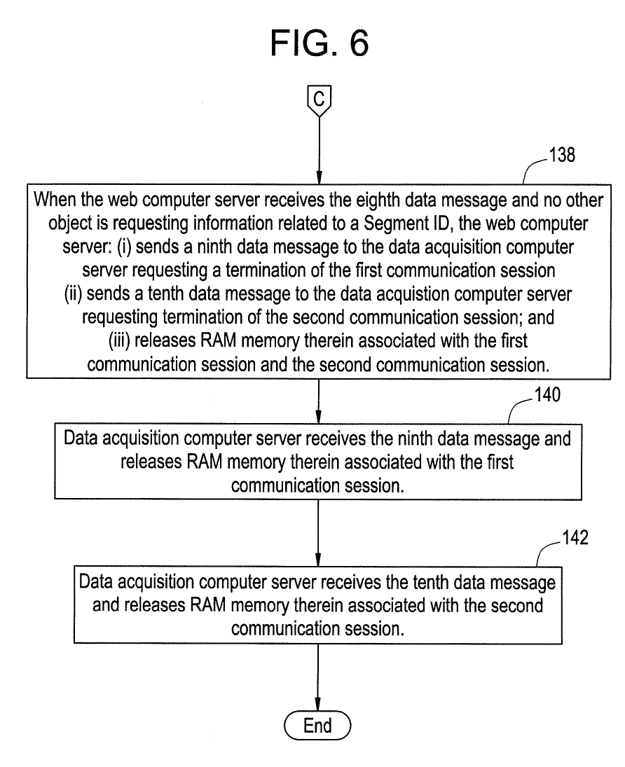

Referring to FIG. 6, next at step 138 when the web computer server 14 receives the eighth data message from embedded software object 74 and no other embedded software object is requesting information related to the Segment ID associated with sensor 52, the web computer server 14 performs the following steps: (i) sends a ninth data message to the data acquisition computer server 16 requesting a termination of the first communication session, (ii) sends a tenth data message to the data acquisition computer server 16 requesting termination of the second communication session, and (iii) releases memory in the RAM 34 associated with the first communication session and the second communication session.

At step 140, the data acquisition computer server 16 receives the ninth data message and releases memory in RAM 44 associated with the first communication session.

At step 142, the data acquisition computer server 16 receives the tenth data message and releases memory in RAM 44 associated with the second communication session.

The networked system and method for managing computer memory in the networked system represents a substantial advantage over known systems and methods. In particular, the method has the technical effect of “cleaning up” or releasing RAM associated with communication sessions between the web computer server and the other computers servers in response to a web page on a client computer being closed or another web page being opened. Thus, additional RAM is available for other user communication sessions or for additional user to communication sessions. Thus, the quality of service for all users of the web computer server and users of the other computers servers communicating with the web computer server is improved.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

1. A method for managing computer memory in a networked system, comprising:
determining when a first web page is being closed or a second web page is being opened on a first computer, the first web page having an embedded software object therein; and,
in response to the first web page being closed or the second web page being opened, executing a software function in the embedded software object that both transmits a first data message to a second computer instructing the second computer to stop sending predetermined information to the embedded software object, and releases memory in the first computer associated with the embedded software object.

2. The method of claim 1 further comprising transmitting a second data message from the second computer to a third computer instructing the third computer to stop sending to the second computer the predetermined information utilized by the embedded software object of the first computer, in response to the second computer receiving the first data message.

3. The method of claim 2 further comprising releasing memory in the second computer allocated for both first communication session with the third computer and for storing the predetermined information received from the third computer.

4. The method of claim 2 wherein the third computer receives the second data message and releases memory allocated in the third computer for both the first communication session with the second computer and for storing the predetermined information received from a sensor.

5. The method of claim 1 wherein the released memory of the first computer is RAM.

6. The method of claim 1 wherein the first data message includes an information identifier that identifies a predetermined measurement value or a predetermined status value received by the second computer.

7. A method for managing computer memory in a networked system, comprising:
determining when a first web page is being closed or a second web page is being opened on a first computer, the first web page having a plurality of embedded software objects therein; and,
in response to the first web page being closed or the second web page being opened, executing a software function in each of the plurality of embedded software objects that both transmits a first data message to a second computer instructing the second computer to stop sending predetermined information to the embedded software object and releases memory in the first computer associated with the embedded software object.

8. A networked system, comprising:
a first computer operably communicating with a second computer, the first computer having a first web page including an embedded software object therein, the first computer in response to the first web page being closed or a second web page being opened, executes a software function in the embedded software object that both transmits a first data message to the second computer instructing the second computer to stop sending predetermined information to the embedded software object and releases memory in the first computer associated with the embedded software object.

9. The networked system of claim 8 wherein the second computer in response to receiving the first data message transmits a second data message to a third computer instructing the third computer to stop sending to the second computer the predetermined information utilized by the embedded software object of the first computer.

10. The networked system of claim 9 wherein the second computer further releases memory allocated for both a first communication session with the third computer and for storing the predetermined information received from the third computer.

11. The networked system of claim 9 wherein the third computer receives the second data message and releases memory allocated in the third computer for the first communication session with the second computer and for storing the predetermined information.

12. The networked system of claim 9 wherein the first data message includes an information identifier that identifies a predetermined measurement value or a predetermined status value received by the second computer from the third computer.

13. The networked system of claim 9 wherein the predetermined information comprises a measured value indicative of an operating parameter of a device.

14. The networked system of claim 9 wherein the predetermined information comprises a status value indicative of whether a device is operating within a predetermined operational range.

15. The networked system of claim 8 wherein the released memory of the first computer is random-access memory.

16. The networked system of claim 8 wherein the embedded software object is configured to display the predetermined information on the first web page.

17. A networked system, comprising:
a first computer operably communicating with a second computer, the first computer having a first web page including a plurality of embedded software objects therein, the first computer in response to the first web page being closed or a second web page being opened, executes a software function in each of the embedded software objects that both transmits a first data message to a second computer instructing the second computer to stop sending predetermined information to the embedded software object and releases memory in the first computer associated with the embedded software object.

18. The networked system of claim 17 wherein the first data message includes an information identifier that identifies a predetermined measurement value or a predetermined status value received by the second computer.

19. The networked system of claim 17 wherein the second computer receives each first data message transmitted from the embedded software object and in response to each first data message transmits a second data message to a third computer instructing the third computer to stop sending to the second computer the predetermined information.

20. The networked system of claim 19 wherein the third computer determines the predetermined information from a measurement signal generated by a sensor communicating the third computer, the measurement signal being indicative of an operating parameter of a device.

21. The networked system of claim 19 wherein the third computer determines the predetermined information from a status signal generated by a sensor communicating the third computer, the status signal being indicative of an operating status of a device.

22. The networked system of claim 17 wherein the released memory of the first computer is random-access memory.
